(19) United States
(12) Patent Application Publication
(10) Pub. No.: US 2021/0130939 A1
(43) Pub. Date: May 6, 2021

(54) Anisotropic Bonded Magnetic Powder and a Preparation Method Thereof

(71) Applicants: GRIREM ADVANCED MATERIALS CO., LTD., Beijing (CN); GRIREM HI-TECH CO., LTD., Langfang City (CN)

(72) Inventors: Yang Luo, Beijing (CN); Zhongkai Wang, Beijing (CN); Yuanfei Yang, Beijing (CN); Zilong Wang, Beijing (CN); Dunbo Yu, Beijing (CN); Yifan Liao, Beijing (CN); Jiajun Xie, Beijing (CN); Zhou Hu, Beijing (CN)

(21) Appl. No.: 17/090,699

(22) Filed: Nov. 5, 2020

(30) Foreign Application Priority Data
Nov. 6, 2019 (CN) 201911076249.X

(51) Int. Cl. C22C 38/16; H01F 1/057; H01F 41/02; C22C 38/06; C22C 38/00; C22C 33/02; B22F 9/04; B22F 1/00

(52) U.S. Cl. CPC C22C 38/16; H01F 1/0578; H01F 41/0253; C22C 38/06; C22C 38/005; C22C 33/02; B22F 2201/013; B22F 1/0085; C22C 2202/02; B22F 2009/041; B22F 2301/355; B22F 2201/20; B22F 9/04

(57) ABSTRACT

The invention discloses an anisotropic bonded magnetic powder and a preparation method thereof. The anisotropic bonded magnetic powder has a general formula of R₁R₂TB, wherein R₁ is a rare earth element containing Nd or PrNd, R₂ is one or two of La and Ce, T is a transitional element, and B is boron. The preparation method includes the steps of smelting the master alloy to prepare ingot(s), preparing a rare earth hydride of formula R₁TBH_{X}, preparing a hydride diffusion source of formula R₁R₂TH_{X}, mixing, heat treating, and high-vacuum dehydrogenating, to obtain the anisotropic bonded magnetic powder. The invention uses La and Ce hydrides as the diffusion source, can save cost, remove hydrogen from the diffusion source at a lower dehydrogenation temperature, avoid crystal grain growth at a high temperature, and ensure the quality of the product.

### TECHNICAL FIELD OF THE INVENTION

The invention relates to the technical field of magnetic materials, in particular to an anisotropic bonded magnetic powder and a preparation method thereof.

### BACKGROUND OF THE INVENTION

Magnets made from anisotropic bonded magnetic powder RTB are widely used as permanent magnetic materials with the best comprehensive performance in the industry, wherein R represents rare earth element(s), T represents transitional element(s), and B represents boron. However, RTB rare earth magnets are sensitive to temperature changes, and has low Curie temperature and poor thermal stability; once it reaches a high temperature, its coercivity will decrease rapidly. As anisotropic magnets have low coercivity, they cannot meet the requirements of application fields such as automotive motors, which have high demands on the thermal stability of magnets at a high temperature. Therefore, it is necessary to pre-manufacture high-coercivity magnetic powders and further process them to obtain high-coercivity magnets, so that the magnets have high coercivity at room temperature enough to resist the thermal demagnetization under high-temperature working environment.

Chinese patent application CN1345073A discloses a method for manufacturing anisotropic magnetic powder. When the diffusion source utilizes a hydride containing Tb or Dy and the rare earth element in RFeBH_{X} is Nd or Pr, as the diffusion source itself contains hydrogen and the heavy rare earth element Tb or Dy requires a higher dehydrogenation temperature to remove the hydrogen from the diffusion source, although a high-temperature dehydrogenation process is carried out after the diffusing heat treatment, this step mainly removes the hydrogen in the RFeBH_{X} rather than the hydrogen in the diffusion source. In order to remove the hydrogen in the diffusion source, a higher diffusing heat treatment temperature is required. However, the high temperature will cause the crystal grains to grow, which ultimately affects the quality and performance of the product. In addition, Tb or Dy has relatively small atomic size, and is relatively easy to enter the interior during diffusion, that is, diffusion is a process that occurs at the same time as the interior and the grain boundary; however, too much diffusion source elements are introduced into the main phase, which destroys the structure of the main phase and ultimately affects the quality and performance of the product.

Chinese patent application CN107424694A discloses a rare earth anisotropic magnet powder and a manufacturing method and bonded magnet thereof. When the rare earth element R₂ in the diffusion source and R′ in the original powder containing Nd are Nd or Pr and the original powder and the diffusion source utilize hydride, the diffusion source with the addition of Cu has a higher melting point of approximate to 680° C., with the other components the same. During the diffusing heat treatment step, the grain boundary diffuses into a form where liquid diffusion source grain boundary phase surrounds the solid original powder main phase. As the diffusion source has a high melting point, the grain boundary diffusion requires an increased working temperature, so that the crystal grains grow at a high temperature, which affects the quality and performance of the product.

### SUMMARY OF THE INVENTION

In order to solve the above problem(s), the invention provides an anisotropic bonded magnetic powder and a preparation method thereof. The method reduces the working temperature of grain boundary diffusion, reduces the degree of grain growth, improves the coercivity of the anisotropic magnets and reduces the magnetic energy product and residual magnetic flux loss at the same time.

In order to achieve the above objectives, the invention adopts the following solutions:

In the first aspect, the invention provides an anisotropic bonded magnetic powder having a general formula of R₁R₂TB, wherein R₁ is a rare earth element containing Nd or PrNd, R₂ is one or two of La and Ce, T is a transitional element, and B is boron;

the weight percentage of each component of the R₁R₂TB anisotropic bonded magnetic powder is as follows: the weight percentage of Nd is 28% to 34.5%, that of Pr is ≤5%, that of B is 0.8% to 1.2%, the total weight percentage of La and Ce accounts for ≤0.1% of the total weight of the anisotropic bonded magnetic powder, and T is the balance;

R₁R₂THₓ, the hydride of R₁R₂T, is used as the diffusion source of rare earth element, and R₁TBHₓ, the hydride of NdTB or PrNdTB, is subjected to grain boundary diffusion at a working temperature of 400-700° C., and the anisotropic bonded magnetic powder is obtained after the high-temperature dehydrogenation step of HDDR.

Further, the ratio of the content of the R₂ element in the grain boundary phase to the content in the main phase is greater than 3.

Further, the anisotropic bonded magnetic powder includes a R₁TB main phase with 2:14:1 grain boundary structure and a grain boundary phase surrounding the main phase.

In the second aspect, the invention provides a method for preparing the anisotropic bonded magnetic powder, comprising the following steps:

smelting the master alloy to form solid ingots R₁TB and R₁R₂T, respectively;

putting the solid ingot R₁TB into a HDDR furnace, and performing hydrogen absorption, high-temperature hydrogenation, and hydrogen discharging to obtain the rare earth hydride R₁TBH_{X};

subjecting the solid ingot R₁R₂T to hydrogen treatment at a temperature of lower than 500° C. to obtain the hydride diffusion source R₁R₂THₓ;

mixing the rare earth hydride R₁TBH_{X} and the diffusion source R₁R₂THₓ;

heat-treating the mixed rare earth hydride R₁TBH_{X} and diffusion source R₁R₂THₓ;

high-vacuum dehydrogenating to obtain the anisotropic bonded magnetic powder.

Further, the step of smelting the master alloy to form solid ingots R₁TB and R₁R₂T, respectively, comprises:

smelting the alloy raw materials at a certain ratio in a vacuum induction furnace in an argon atmosphere, melting at a high temperature, casting the raw materials into a mold with a thickness of 30-35 mm, to form an ingot after the rapid water-cooling of the metal liquid in the mold;

putting the ingot into a vacuum heat treatment furnace in a high vacuum environment, and keeping the furnace at a temperature of 1000° C. to 1100° C. for 20 hours;

filling the furnace with argon gas to −0.01 MPa, performing rapid air cooling under constant pressure, and removing the solid ingot out of the furnace after cooling down to room temperature.

Further, the step of putting the solid ingot R₁TB into a HDDR furnace and performing hydrogen absorption, high-temperature hydrogenation, and hydrogen discharging to obtain the rare earth hydride R₁TBH_{X}, comprises:

putting the solid ingot R₁TB into a HDDR furnace, raising the temperature to 300° C. under vacuum, then filling the furnace with hydrogen at this temperature to maintain the gas pressure at 95-100 kPa, and keeping the furnace at 300° C. for 1 to 2 hours to complete the hydrogen absorption treatment;

vacuum-pumping to 30-35 kPa, heating up to 790° C., and keeping the furnace at this temperature and pressure for 180-200 minutes to complete the high-temperature hydrogenation treatment;

filling the furnace with hydrogen gas to 50-70 kPa, heating up to 820° C., and keeping the furnace at this temperature for 30 minutes;

vacuum-pumping to 0.1-4 kPa, keeping the furnace at this temperature for 20 minutes to complete the hydrogen discharging step.

Further, the step of subjecting the solid ingot R₁R₂T to hydrogen treatment at a temperature of lower than 500° C. to obtain the hydride diffusion source R₁R₂THₓ comprises:

crushing solid ingot R₁R₂T roughly and putting it in a gas-solid reaction furnace, heating up to 300-500° C. under vacuum, filling the furnace with hydrogen at this temperature, maintaining the gas pressure at 95-100 kPa, and keeping the furnace at this temperature for 80 minutes to complete the hydrogen absorption and decomposition;

vacuum-pumping and cooling down to room temperature at the same time to obtain hydride diffusion source R₁R₂THₓ.

Further, the step of mixing the rare earth hydride R₁TBH_{X} and the diffusion source R₁R₂THₓ comprises:

mixing the rare earth hydride R₁TBH_{X} and the diffusion source R₁R₂THₓ by using a blender in a mixed atmosphere of Ar and N₂ for 15-30 minutes.

Further, the step of heat-treating the mixed rare earth hydride R₁TBH_{X} and the diffusion source R₁R₂THₓ comprises:

preferably selecting a mixed atmosphere of Ar and N₂ as the heat treatment atmosphere, and keeping the mixed powder of rare earth hydride R₁TBHₓ, and diffusion source R₂TBHₓ at 400-700° C. under vacuum for 0.5-2 hours to complete the heat treatment process.

Further, the step of high-vacuum dehydrogenating to obtain the anisotropic bonded magnetic powder comprises:

maintaining the air pressure at 0.1 Pa or less at a temperature of 600-850° C., and continuously vacuum-pumping for 60-80 minutes; preferably, performing high-vacuum dehydrogenation and the above step of diffusing heat treatment at 600-700° C. simultaneously;

then quickly cooling down to room temperature.

In conclusion, the invention discloses an anisotropic bonded magnetic powder and a preparation method thereof. The anisotropic bonded magnetic powder has a general formula of R₁R₂TB, wherein R₁ is a rare earth element containing Nd or PrNd, R₂ is one or two of La and Ce, T is a transitional element, and B is boron; the preparation method includes the steps of smelting the master alloy to prepare ingot(s), preparing a rare earth hydride of formula R₁TBH_{X}, preparing a hydride diffusion source of formula R₁R₂TH_{X}, mixing, heat treating, and high-vacuum dehydrogenating, to obtain the anisotropic bonded magnetic powder. The invention uses La and Ce hydrides as the diffusion source, can remove hydrogen from the diffusion source at a lower dehydrogenation temperature, avoid crystal grain growth at a high temperature, and ensure the quality of the product.

The above technical solutions of the invention have the following beneficial technical effects:

(1) La and Ce elements are used to replace Tb and Dy elements in the prior art, which can save costs and protect heavy rare earth resources;

(2) When La and Ce hydrides are used as the diffusion source and the rare earth elements in RFeBH_{X} are Nd or Pr, the hydrogen in the diffusion source can be removed at a lower dehydrogenation temperature in the case of La and Ce, as compared in the case of Nd or Pr, and diffusing heat treatment and the high-temperature dehydrogenation process are carried out at a lower temperature. At the said lower dehydrogenation temperature, not only the hydrogen in the RFeBH_{X} but also that in the diffusion source can be removed, and thus higher diffusing heat treatment temperature is not required, which avoids crystal grain growth at a high temperature and improves the coercivity while reducing the magnetic energy product and residual magnetic flux loss.

### DETAILED DESCRIPTION OF THE INVENTION

In order to make the objectives, technical solutions, and advantages of the invention clearer, the invention is further illustrated in detail below in conjunction with specific embodiments. It should be understood that these descriptions are only exemplary and are not intended to limit the scope of the invention. In addition, in the following section, descriptions of well-known structures and technologies are omitted to avoid unnecessarily obscuring the concept of the invention.

In the first aspect, the invention provides an anisotropic bonded magnetic powder of formula R₁R₂TB, wherein R₁ represents a rare earth element containing Nd or PrNd, R₂ represents one or two of La and Ce, T represents a transitional element, and B represents boron. A shell structure in which the R₂ grain boundary phase surrounds the R₁ main phase is formed, and the ratio of the volume of the main phase to the volume of the grain boundary phase is between 10 and 30. La and Ce elements are used to replace Tb and Dy elements in the prior art, which can save costs and protect heavy rare earth resources. R₁R₂THₓ, the hydride of R₁R₂T, is used as the diffusion source of rare earth element. For the diffusion source R₁R₂THₓ, the invention uses La or Ce in stead of Tb or Dy as the R₂ element. As R₂ has a lower melting point than R₁, the reaction that forms partial liquid phase diffusion source surrounding solid main phase can take place at a low temperature. Magnetic powder of R₁TBHₓ, the hydride of NdTB or PrNdTB, is subjected to grain boundary diffusion at a working temperature of 400-700° C., and after the high-temperature dehydrogenation step of HDDR, a rare earth anisotropic bonded magnetic powder is obtained with the formula of R₁R₂TB. The particles of the anisotropic bonded magnetic powder include a R₁TB main phase with 2:14:1 grain boundary structure and a grain boundary phase surrounding the main phase.

In R₁R₂TH_{X}, the weight percentage of Nd is 70% to 80%, that of Pr is ≤5%, that of La is ≤0.05%, that of Ce is ≤0.05%, that of H is ≤0.1%, and T is the balance; in R₁TBH_{X}, the weight percentage of Nd is 28% to 29.5%, that of Pr is ≤5%, that of B is 0.9% to 1.2%, that of H is ≤0.1%, and T is the balance; the adding ratio of R₁R₂TH_{X} is: setting the weight of R₁TBH_{X} as 100%, the weight of R₁R₂TH_{X} is 0.1% to 10%.

Further, during the diffusion process, most of the R₂ is diffused outside the crystal grains, and a few are diffused inside the crystal grains, and thus the ratio of the content in the grain boundary phase to that in the main phase is greater than 3. Preferably, the ratio of the content of the R₂ element in the grain boundary phase to that in the main phase is greater than 3 and less than 10. For the diffusion source R₁R₂T, the invention uses La or Ce instead of Tb or Dy as the R₂ element, and the diffusion reaction that occurs at this time is basically limited in the grain boundary phase, rather than the internal reaction. During the diffusion process of La or Ce, most of them are diffused outside the crystal grains, and a few are diffused within the crystal grains, and thus the ratio of the content in the grain boundary phase to that in the main phase is greater than 3. A good diffusion process can greatly increase the coercivity. However, if the diffusion source is excessively added, on the one hand, the magnetic energy product and remanence will be greatly reduced, and on the other hand, La or Ce in the main phase will increase, which will inevitably lead to impure main phase products. Therefore, it is preferable to set the ratio of the content of the R₂ element in the grain boundary phase to that in the main phase to be greater than 3 and less than 10.

In the second aspect, the invention provides a method for preparing the rare earth anisotropic bonded magnetic powder R₁R₂TB, comprising the following steps:

Step 1: the master alloy is smelt to form solid ingots R₁TB and R₁R₂T, respectively. Take the former R₁TB as an example:

the alloy raw materials are smelt at a certain ratio in a vacuum induction furnace in a high-purity argon atmosphere, melt at a high temperature, and then the raw materials are cast into a mold with a thickness of 30-35 mm, to form an ingot after the rapid water-cooling of the metal liquid in the mold; the ingot is put into a vacuum heat treatment furnace in a high vacuum environment, and kept at a temperature of 1000° C. to 1100° C. for 20 hours; the furnace is filled with argon gas to −0.01 MPa, and then rapidly cooled down by air under constant pressure; the solid ingot is removed out of the furnace after cooling down to room temperature; the product at this stage is an solid ingot R₁TB, without anisotropy.

The solid ingot R₁R₂T is prepared in the same way as above.

Step 2: an anisotropic powder having rare earth hydride R₁TBHₓ as the main component is prepared. The solid ingot R₁TB is put into a HDDR furnace, and subjected to hydrogen absorption, high-temperature hydrogenation, and hydrogen discharging to prepare the rare earth hydride R₁TBH_{X}.

Specifically, the above-mentioned ingot R₁TB is placed in a HDDR furnace, the temperature is raised up to 300° C. under vacuum, and then the furnace is filled with hydrogen at this temperature to maintain the gas pressure at 95-100 kPa and kept at 300° C. for 1 to 2 hours to complete the step of hydrogen absorption and decomposition.

Then, the furnace is vacuum-pumped to 30-35 kPa, heated up to 790° C., and maintained at this temperature and pressure for 180-200 minutes to complete the high-temperature hydrogenation process.

Then, the furnace is filled with hydrogen to 50-70 kPa, and at the same time heated up to 820° C. and kept at this temperature for 30 minutes.

Finally, the furnace is vacuum-pumped to 0.1-4 kPa and kept at this temperature for 20 minutes to complete the first exhaust process. At this time, because the high-temperature dehydrogenation process has not been completed, it is not a complete HDDR process.

During the reaction process, the inter-crystal structure of R₁TB will break due to different expansion coefficients in the process of hydrogen absorption, and form a fine powder with an average crystal grain size of 300 nm and a phase structure of 2:14:1. As a disproportionation decomposition reaction occurs during the high-temperature hydrogenation process, the R₁TB main phase structure is decomposed into R₁H₂+Fe₂B+Fe three-phase structure, and a crystal structure along the C axis direction of the main phase is produced, making the product anisotropic. The first exhaust process removes the hydrogen of R₁H₂ in the three phases, and at the same time the crystal orientation of the Fe₂B phase is transformed into the polycrystal recombination hydride R₁TBHₓ, which is different from the product R₁TB of the complete HDDR process because it has not undergone the high-temperature dehydrogenation process.

Step 3: a diffusion source having R₁R₂THₓ as the main component is prepared by a hydrogen treatment method, and the hydrogen treatment temperature is less than 500° C.

Specifically, hydrogen treatment: the solid ingot R₁R₂T is roughly crushed and placed in a gas-solid reaction furnace; the furnace is heated up to 300-500° C. under vacuum, and filled with hydrogen at this temperature, maintaining the gas pressure at 95-100 kPa, and keeping at this temperature for 80 minutes to complete the hydrogen absorption and decomposition. The furnace is vacuum-pumped and cooled down to room temperature at the same time, to obtain the hydride R₁R₂THₓ diffusion source.

When La and Ce hydrides are used as the diffusion source instead of Tb and Dy hydrides and the rare earth element in RFeBH_{X} is Nd or Pr, the hydrogen in the diffusion source can be removed at a lower dehydrogenation temperature in the case of La and Ce, as compared with the case of Nd or Pr. The high-temperature dehydrogenation process is carried out after the diffusion heat treatment. At the said dehydrogenation temperature, not only the hydrogen in the RFeBH_{X} but also that in the diffusion source can be removed, and thus higher diffusing heat treatment temperature is not required, which avoids crystal grain growth at a high temperature and ensures the quality and property of the product.

Step 4: the raw powders, namely, the rare earth hydride and the diffusion source, are mixed to obtain the mixed powder. Specifically, the raw powders are mixed for 15-30 minutes in a mixed atmosphere of Ar and N₂ in a mixer.

Step 5: the mixed powder is subjected to heat treatment. In the heat treatment step, the heat treatment atmosphere is preferably a mixed atmosphere of Ar and N₂. That is, the mixed powder of rare earth hydride R₁TBHₓ and diffusion source R₂TBHₓ is kept in a vacuum state at 400-700° C. for 0.5-2 hours to complete the heat treatment process.

Step 6: an anisotropic bonded magnetic powder is obtained after high-vacuum dehydrogenation. Specifically, the furnace is maintained at an air pressure of 0.1 Pa or less at a temperature of 600-850° C. and continuously vacuum-pumped for 60-80 minutes; then it is quickly cooled down to room temperature. This step can be performed after the heat treatment, or can occur simultaneously with the diffusion heat treatment at a relatively low temperature, that is, the diffusion heat treatment and the high vacuum dehydrogenation are performed simultaneously at 600-700° C.

### SUPPLEMENTARY EXAMPLES

### Example 1: A1-B1˜B3

1: Preparation of R₁TB and R₁R₂T Ingot Raw Material

Alloy raw materials were weighed according to the composition of Table 1 and Table 2, where the whole alloy was expressed as 100% by weight, and each element was expressed by weight percentage in wt %. The alloy raw materials were smelt in a vacuum induction furnace in a high-purity argon atmosphere, melt at a high temperature and then the raw materials were cast into a mold with a thickness of 30-35 mm. The metal liquid was rapidly water-cooled in the mold to form an ingot.

The ingot was put into a vacuum heat treatment furnace, and kept at 1000° C.-1100° C. for 20 hours in a vacuum environment. The furnace was filled with argon gas to −0.01 MPa, and then rapidly cooled down by air under constant pressure; the solid ingot was removed out of the furnace after cooling down to room temperature; the product at this stage was an solid ingot R₁TB. The ingot was roughly crushed to small pieces with an average particle size of 20-35 mm.

The ingot here might also be replaced with a strip prepared by the SC casting method.

TABLE 1

Components (wt %)

| R₁TB alloy | Nd | Pr | B | Ga | Nb | Fe |
|---|---|---|---|---|---|---|
| Ingot A1 | 28.8 | | 1 | | | balance |
| SC strip A2 | 28.8 | 3.5 | 1 | 0.3 | 0.3 | balance |

TABLE 2

| R₁R₂T | | | | | | | |
|---|---|---|---|---|---|---|---|
| alloy raw | Components (wt %) | | | | | | |
| materials | Nd | Pr | La | Ce | Al | Dy | Cu |
| B1 | 80 | | | | 10 | | 10 |
| B2 | 79 | | 0.2 | 0.2 | 10 | | 10 |
| B3 | 78 | | 0.5 | 0.5 | 10 | | 10 |
| B4 | 79.6 | | | | 10 | 0.4 | 10 |
| B5 | 78.6 | | 0.3 | 0.3 | 10 | 0.4 | 10 |
| B6 | 77.6 | | 0.5 | 0.5 | 10 | 0.4 | 10 |
| B7 | 75.6 | 3 | 0.4 | 0.4 | 10 | 0.3 | 10 |

2: Preparation of R₁TBH_{X} and R₁R₂TH_{X}

The solid ingot or the iron sheet R₁TB prepared by the SC method was put into a HDDR furnace, the temperature was raised up to 300° C. under vacuum, then the furnace was filled with hydrogen at this temperature to maintain the gas pressure at 95-100 kPa, and kept at 300° C. for 1 to 2 hours to complete the step of hydrogen absorption and decomposition. The hydrogen pressure was controlled at 30-35 kPa, the temperature was further raised up to 790° C., and the furnace was maintained at this temperature and pressure for 180-200 minutes. Then the furnace was filled with hydrogen to 50˜70 kPa, further heated up to 820° C., and kept for 30 minutes to complete the high-temperature hydrogenation process. The furnace was vacuum-pumped to 0.1-4 kPa and kept at this temperature for 20 minutes to complete the first exhaust process to obtain R₁TBH_{X}.

The diffusion source was prepared by a hydrogen treatment method with the hydrogen treatment temperature less than 500° C. The solid ingot or SC sheet R₁R₂T was put placed in a gas-solid reaction furnace. The furnace was heated up to 300-500° C. under vacuum, and filled with hydrogen at this temperature, maintaining the gas pressure at 95-100 kPa, and keeping at this temperature for 80 minutes to complete the hydrogen absorption and decomposition. The furnace was vacuum-pumped and cooled down to room temperature at the same time to obtain a hydride R₁R₂THₓ diffusion source with a particle size below 300 μm. The powder was ground to obtain R₁R₂THₓ fine powder with a particle size less than 80 μm.

3: Mixing

R₁TBH_{X} and R₁R₂TH_{X} fine powders were mixed.

4: Diffusing Heat Treatment

The mixed powder was subjected to heat treatment at 400-700° C. under a vacuum pressure of 10⁻² Pa.

5: High-Vacuum Dehydrogenation

The powder after the heat treatment was subjected to heat treatment at 600-850° C. under a vacuum pressure of 10⁻⁴ Pa.

Example 2: A1˜B4˜B6, the method was the same as in Example 1.

Example 3: A1 or A2-B7, the method was the same as in Example 1.

TABLE 3

| | R₁TB | R₁R₂T | | Components of the mixed magnetic powder (weight %) | | | | | | | | |
|---|---|---|---|---|---|---|---|---|---|---|---|---|
| No. | Type | Type | Weight | Nd | Pr | Dy | Al | Cu | B | Ga | Nb | Fe |
| Example 1 | A1 | B1 | 6% | 31.87 | | | 0.6 | 0.6 | 0.94 | | | balance |
| | A1 | B2 | 6% | 31.81 | | | 0.6 | 0.6 | 0.94 | | | balance |
| | A1 | B3 | 6% | 31.75 | | | 0.6 | 0.6 | 0.94 | | | balance |
| | A1 | B1 | 6% | 31.87 | | | 0.6 | 0.6 | 0.94 | | | balance |
| | A1 | B2 | 6% | 31.81 | | | 0.6 | 0.6 | 0.94 | | | balance |
| | A1 | B3 | 6% | 31.75 | | | 0.6 | 0.6 | 0.94 | | | balance |
| Example 2 | A1 | B4 | 3% | 30.32 | | 0.01 | 0.3 | 0.3 | 0.97 | | | balance |
| | A1 | B5 | 3% | 30.29 | | | 0.3 | 0.3 | 0.97 | | | balance |
| | A1 | B6 | 3% | 30.26 | | | 0.3 | 0.3 | 0.97 | | | balance |
| | A1 | B4 | 10% | 33.88 | | 0.04 | 1 | 1 | 0.9 | | | balance |
| | A1 | B5 | 10% | 33.78 | | 0.04 | 1 | 1 | 0.9 | | | balance |
| | A1 | B6 | 10% | 33.688 | | 0.04 | 1 | 1 | 0.9 | | | balance |
| Example 3 | A1 | B7 | 1% | 28.85 | | 0.003 | 0.1 | 0.1 | 0.99 | | | balance |
| | A2 | B7 | 1% | 28.85 | 3.495 | 0.003 | 0.1 | 0.1 | 0.99 | 0.297 | 0.297 | balance |
| | A2 | B7 | 10% | 33.48 | 3.45 | 0.03 | 1 | 1 | 0.9 | 0.27 | 0.27 | balance |

| | | | | | | Magnetic | | |
|---|---|---|---|---|---|---|---|---|
| | | Components of the mixed | | Diffusion | | performance | | |
| | R₁TB | magnetic powder (weight %) | | temperat | Dehyd | | | BH(max) |
| No. | Type | La | Ce | ° C. | ° C. | Hcj kA/ | BrT | kJ/m³ |
| Example 1 | A1 | | | 400 | 850 | 1052 | 1.30 | 268 |
| | A1 | 0.01 | 0.01 | 400 | 850 | 1406 | 1.37 | 326 |
| | A1 | 0.03 | 0.03 | 400 | 850 | 1252 | 1.32 | 303 |
| | A1 | | | 700 | 850 | 1311 | 1.34 | 311 |
| | A1 | 0.01 | 0.01 | 700 | 850 | 1426 | 1.39 | 331 |
| | A1 | 0.03 | 0.03 | 700 | 850 | 1320 | 1.33 | 308 |
| Example 2 | A1 | | | 600 | 600 | 1168 | 1.32 | 307 |
| | A1 | 0.01 | 0.01 | 600 | 600 | 1412 | 1.40 | 337 |
| | A1 | 0.02 | 0.02 | 600 | 600 | 1422 | 1.36 | 318 |
| | A1 | | | 900 | 850 | 1288 | 1.18 | 210 |
| | A1 | 0.03 | 0.03 | 900 | 850 | 1442 | 1.26 | 258 |
| | A1 | 0.05 | 0.05 | 900 | 850 | 1488 | 1.21 | 239 |
| Example 3 | A1 | 0.004 | 0.004 | 350 | 850 | 1010 | 1.28 | 282 |
| | A2 | 0.004 | 0.004 | 650 | 650 | 1142 | 1.32 | 307 |
| | A2 | 0.04 | 0.04 | 700 | 700 | 1462 | 1.28 | 284 |

It can be seen from the above table that the addition of a diffusion source containing La or Ce makes the diffusion reaction easier. A good diffusion reaction can occur at 400° C., and the coercivity of the magnetic powder is greatly improved. When the weight percentage of each of La and Ce is 0.01%, the coercivity reaches 1406 kA/m, while the coercivity after diffusion without adding La or Ce in the diffusion reaction is only 1052 kA/m at a low temperature. In addition, as compared with the diffusion source containing Dy hydride, the diffusion source containing La or Ce hydride is more easily dehydrogenated at a lower temperature. In this experiment, the diffusion reaction occurred at a lower temperature of 600° C., and the dehydrogenation reaction was carried out at the same time. At the said dehydrogenation temperature, not only the hydrogen in the RFeBH_{X} but also that in the diffusion source can be removed, and thus higher diffusing heat treatment temperature is not required, which avoids crystal grain growth at a high temperature and is manifested as an improvement in coercivity performance.

In conclusion, the invention provides an anisotropic bonded magnetic powder and a preparation method thereof. The anisotropic bonded magnetic powder has a general formula of R₁R₂TB, wherein R₁ is a rare earth element containing Nd or PrNd, R₂ is one or two of La and Ce, T is a transitional element, and B is boron. The preparation method includes the steps of smelting the master alloy to prepare ingot(s), preparing a rare earth hydride of formula R₁TBH_{X}, preparing a hydride diffusion source of formula R₁R₂TH_{X}, mixing, heat treating, and high-vacuum dehydrogenating, to obtain the anisotropic bonded magnetic powder. The invention uses La and Ce hydrides as the diffusion source, can remove hydrogen from the diffusion source at a lower dehydrogenation temperature, avoid crystal grain growth at a high temperature, and ensure the quality of the product.

It should be understood that the foregoing specific embodiments of the invention are only used to exemplarily illustrate or explain the principle of the invention, and do not constitute any limitation to the invention. Therefore, any modifications, equivalent substitutions, improvements, and the like made without departing from the spirit and scope of the invention should be included in the protection scope of the invention. In addition, the appended claims of the invention are intended to cover all changes and modifications that fall within the scope and boundary of the appended claims, or equivalent forms of such scope and boundary.

1. An anisotropic bonded magnetic powder, wherein the anisotropic bonded magnetic powder has a general formula of R₁R₂TB, wherein R₁ is a rare earth element containing Nd or PrNd, R₂ is one or two of La and Ce, T is a transitional element, and B is boron;
the weight percentage of each component of the R₁R₂TB anisotropic bonded magnetic powder is as follows: the weight percentage of Nd is 28% to 34.5%, that of Pr is ≤5%, that of B is 0.8% to 1.2%, the total weight percentage of La and Ce accounts for ≤0.1% of the total weight of the anisotropic bonded magnetic powder, and T is the balance;
R₁R₂THₓ, the hydride of R₁R₂T, is used as the diffusion source of rare earth element, and R₁TBHₓ, the hydride of NdTB or PrNdTB, is subjected to grain boundary diffusion at a working temperature of 400-700° C., and the anisotropic bonded magnetic powder is obtained after the high-temperature dehydrogenation step of HDDR.

2. The anisotropic bonded magnetic powder according to claim 1, wherein the ratio of the content of the R₂ element in the grain boundary phase to the content in the main phase is greater than 3.

3. The anisotropic bonded magnetic powder according to claim 1, wherein the anisotropic bonded magnetic powder includes a R₁TB main phase with 2:14:1 grain boundary structure and a grain boundary phase surrounding the main phase.

4. A method for preparing the anisotropic bonded magnetic powder according to claim 1, wherein it comprises the following steps:
smelting the master alloy to form solid ingots R₁TB and R₁R₂T, respectively;
putting the solid ingot R₁TB into a HDDR furnace, and performing hydrogen absorption, high-temperature hydrogenation, and hydrogen discharging to obtain the rare earth hydride R₁TBH_{X};
subjecting the solid ingot R₁R₂T to hydrogen treatment at a temperature of lower than 500° C. to obtain the hydride diffusion source R₁R₂THₓ;
mixing the rare earth hydride R₁TBH_{X} and the diffusion source R₁R₂THₓ;
heat-treating the mixed rare earth hydride R₁TBH_{X} and diffusion source R₁R₂THₓ;
high-vacuum dehydrogenating to obtain the anisotropic bonded magnetic powder.

5. The method according to claim 4, wherein the step of smelting the master alloy to form solid ingots R₁TB and R₁R₂T, respectively, comprises:
smelting the alloy raw materials at a certain ratio in a vacuum induction furnace in an argon atmosphere, melting at a high temperature, casting the raw materials into a mold with a thickness of 30-35 mm, to form an ingot after the rapid water-cooling of the metal liquid in the mold;
putting the ingot into a vacuum heat treatment furnace in a high vacuum environment, and keeping the furnace at a temperature of 1000° C. to 1100° C. for 20 hours;
filling the furnace with argon gas to −0.01 MPa, performing rapid air cooling under constant pressure, and removing the solid ingot out of the furnace after cooling down to room temperature.

6. The method according to claim 4, wherein the step of putting the solid ingot R₁TB into a HDDR furnace and performing hydrogen absorption, high-temperature hydrogenation, and hydrogen discharging to obtain the rare earth hydride R₁TBH_{X}, comprises:
putting the solid ingot R₁TB into a HDDR furnace, raising the temperature to 300° C. under vacuum, then filling the furnace with hydrogen at this temperature to maintain the gas pressure at 95-100 kPa, and keeping the furnace at 300° C. for 1 to 2 hours to complete the hydrogen absorption treatment;
vacuum-pumping to 30-35 kPa, heating up to 790° C., and keeping the furnace at this temperature and pressure for 180-200 minutes to complete the high-temperature hydrogenation treatment;
filling the furnace with hydrogen gas to 50-70 kPa, heating up to 820° C., and keeping the furnace at this temperature for 30 minutes;
vacuum-pumping to 0.1-4 kPa, keeping the furnace at this temperature for 20 minutes to complete the hydrogen discharging step.

7. The method according to claim 4, wherein the step of subjecting the solid ingot R₁R₂T to hydrogen treatment at a temperature of lower than 500° C. to obtain the hydride diffusion source R₁R₂THₓ comprises:
crushing solid ingot R₁R₂T roughly and putting it in a gas-solid reaction furnace, heating up to 300-500° C. under vacuum, filling the furnace with hydrogen at this temperature, maintaining the gas pressure at 95-100 kPa, and keeping the furnace at this temperature for 80 minutes to complete the hydrogen absorption and decomposition;
vacuum-pumping and cooling down to room temperature at the same time to obtain hydride diffusion source R₁R₂THₓ.

8. The method according to claim 4, wherein the step of mixing the rare earth hydride R₁TBH_{X} and the diffusion source R₁R₂THₓ comprises:
mixing the rare earth hydride R₁TBH_{X} and the diffusion source R₁R₂THₓ by using a blender in a mixed atmosphere of Ar and N₂ for 15-30 minutes.

9. The method of claim 4, wherein the step of heat-treating the mixed rare earth hydride R₁TBH_{X} and the diffusion source R₁R₂THₓ comprises:
preferably selecting a mixed atmosphere of Ar and N₂ as the heat treatment atmosphere, and keeping the mixed powder of rare earth hydride R₁TBHₓ and diffusion source R₂TBHₓ at 400-700° C. under vacuum for 0.5-2 hours to complete the heat treatment process.

10. The method according to claim 4, wherein the step of high-vacuum dehydrogenating to obtain the anisotropic bonded magnetic powder comprises:
maintaining the air pressure at 0.1 Pa or less at a temperature of 600-850° C., and continuously vacuum-pumping for 60-80 minutes; preferably, performing diffusing heat treatment and high-vacuum dehydrogenation at 600-700° C. simultaneously;
then quickly cooling down to room temperature.

11. The method according to claim 4, wherein the ratio of the content of the R₂ element in the grain boundary phase to the content in the main phase is greater than 3.

12. The method according to claim 4, wherein the anisotropic bonded magnetic powder includes a R₁TB main phase with 2:14:1 grain boundary structure and a grain boundary phase surrounding the main phase.
